(19) United States
(12) Patent Application Publication
(10) Pub. No.: US 2006/0083126 A1
(43) Pub. Date: Apr. 20, 2006

(54) Methods and apparatuses of half-wave layer jump control for optical disk drive

(75) Inventors: Feng-Fu Lin, Taipei (TW); Chih-Han Liu, Taipei (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 11/236,642

(22) Filed: Sep. 28, 2005

(30) Foreign Application Priority Data
Oct. 19, 2004 (TW) 093131614

(51) Int. Cl. G11B 7/00

(52) U.S. Cl. 369/44.29; 369/44.27; 369/53.28

(57) ABSTRACT

An apparatus for controlling half-wave layer jumping of a pickup head of an optical disk drive includes a half-wave layer jump controller and an output logic unit. The controller receives a focus error signal from a preamplifier to generate a control signal according to the half wave of the focus error signal. The output logic unit outputs a kickout signal, a half-wave layer jump control compensation, and a brake signal in accordance with the timing of the half-wave layer jump control. The output signal are added to a gap balance signal, and the sum is used for controlling layer jumping of the pickup head. Such method adopts an error obtained by comparing the focus error signal with an ideal cycle signal as an additional compensational force for layer jumping.

### FIELD OF THE INVENTION

The present invention relates to methods and apparatuses of half-wave layer jump control for a pickup head of an optical disk drive, and more particularly, to a method and an apparatus capable of controlling the half-wave layer jumping of a pickup head in accordance with a combined reflective light.

### BACKGROUND

There are a number of different types of DVD discs available in the market, such as single-sided single-layer DVD disks, single-sided dual-layer DVD disks, double-sided single-layer DVD disks, and double-sided dual-layer DVD disks. Pickup heads in DVD disk drives must be capable of performing layer jumping for reading or writing any dual-layer or multi-layer optical disks.

Please refer to FIG. 1 for a schematic view of the pickup head reading a dual-layered DVD disk. In FIG. 1, a voice coil motor 120 controls the vertical displacement of an objective lens 110 of a pickup head.

Please refer to FIG. 2 for a schematic circuit diagram of an exemplary system for layer jump control. First of all, the feedback control for focusing performed by a pickup head 210 is described as follows: a preamplifier 220 receives a signal output from the pickup head 210 and outputs a focus error signal; and a controller 230 outputs a focus control signal according to the focus error signal so as to control the pickup head 210 through a driver 250. When the pickup head 210 is jumping from a layer to another layer, the DVD disk drive sends a half-wave Layer Jump Control signal to control an electronic switch 260 to switch the receiving path of the driver 250. An open circuit is formed between the driver 250 and the pickup head 210, in which a low-pass filter 240 receives the focus control signal and outputs a gap balance signal as a direct current (DC) potential of the kickout/brake signal. After combining the gap balance signal and the kickout/brake signal by an adder 247, the resulting combined signal will be used as a control signal for the driver 250. The driver 250 generates a drive control force to control the layer jumping motion of the pickup head 210.

Please refer to FIG. 3 for a schematic view of timing for controlling layer jumping of the pickup head as depicted in FIG. 2. The descending edge of a layer jumping control flag signal represents that the pickup head starts layer jumping. The kickout signal adds the gap balance signal output from a low-pass filter to generate a layer jumping force for enabling the pickup head to displace and jump from one layer to another layer.

As to the entire motion for layer jumping of the pickup head, although the kickout/brake signal received by the driver 250 is added to the gap balance signal at the moment of switching from close-loop focusing control to layer jumping control, the layer balance force applied during the transition from focusing control to layer jumping control is continuous, as a result, the stability of layer jumping motion is maintained.

During layer jumping, the driver 250 and the pickup head 210 constitute an open-loop circuit, and thus there will be no feedback control during layer jumping to reflect whether the DVD drive 210 is controlled at high-speed or low-speed when the pickup head 210 starts layer jumping.

If a pickup head performs layer jumping, the vibration effect produced by the vibration between the disc and mechanism belongs to a lower frequency response. In other words, such vibration is caused by a sled motor that carries the pickup head. The time taken for the pickup head to perform layer jumping at low-speed is considered as a quick process with respect to a cycle of a low-speed motion. Therefore, when the pickup head operates at low-speed while jumping from one layer to another layer, the vibration produced between a disc and the mechanism will not affect layer jumping significantly.

If a pickup head operates at high speed while jumping from one layer to another layer, the foregoing vibration effect will become significant to layer jumping motion. In addition, the time taken for the layer jumping motion of the pickup head operated at a high speed is considered as a slow process with respect to a cycle of a high-speed motion. Therefore, the control force obtained by adding the kickout signal to the gap balance signal cannot totally overcome the vibration effect occurred during layer jumping at high-speed.

There is no feedback control during layer jumping of a pickup head which reflects whether the DVD drive is controlled to operate at high-speed or low-speed, and especially it is advantageous for the DVD drive to control the layer jumping motion with the knowledge of knowing that a high-speed.

In view of the foregoing shortcomings, methods and apparatuses for controlling a pickup head of an optical disk drive to perform half-wave layer jumping, and more particularly to improve the stability of the pickup head while performing layer jumping at high-speed.

### SUMMARY

Embodiments of the present invention enhance the stability of a pickup head that jumps from one layer to another layer. An apparatus for controlling half-wave layer jumping of a pickup head of an optical disk drive is provided. The apparatus comprises a half-wave Layer Jump Controller and an output logic unit, wherein the half-wave controller receives a focus error signal output from a preamplifier and outputs a control signal according to the period of the half-wave cycle of the focus error signal. The output logic unit receives a kickout signal, a control signal and a brake signal output from the half-wave layer jumping controller, and determines the output timing. The output signal is added to a gap balance signal to output a layer jumping control signal for controlling the driver to perform layer jumping of the pickup head.

In some embodiments of the present invention, the half-wave Layer Jump Controller further comprises an adder, a first gain amplifier, a controller, and a second gain amplifier. The adder receives a half-wave wavelength of the focus error signal and an ideal cycle to compute an error. The first gain amplifier receives and amplifies the output of the first adder. The controller receives and controls the output of the first gain amplifier. The second gain amplifier receives and amplifies the output of the controller as the control signal.

Methods for controlling half-wave layer jumping of a pickup head of an optical disk drive are also provided. In some embodiments, the method comprises providing an ideal half-wave cycle, comparing the half wavelength and the first half-wave of the focus error signal used for layer jumping, and assigning weights to the gap balance signal for layer jumping according to the comparison result.

In some embodiments, the method further comprises comparing an ideal half-wave cycle with a first half-wave cycle of an actual focus error signal, and giving weights to the gap balance signal according to an error between the ideal half-wave cycle and the first half-wave cycle of the actual focus error signal.

### BRIEF DESCRIPTION OF THE DRAWINGS

FIG. 1 is a schematic view of a pickup head reading a double-sided DVD disc.

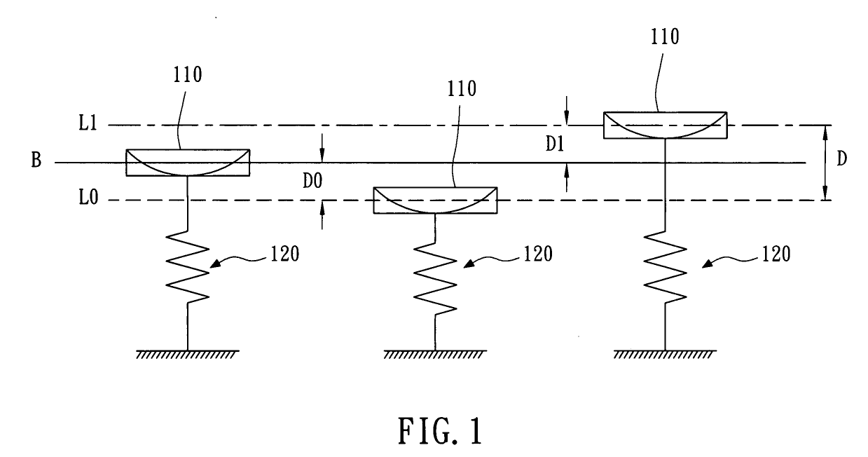

FIG. 2 is a block diagram of an optical disc drive capable of layer jumping.

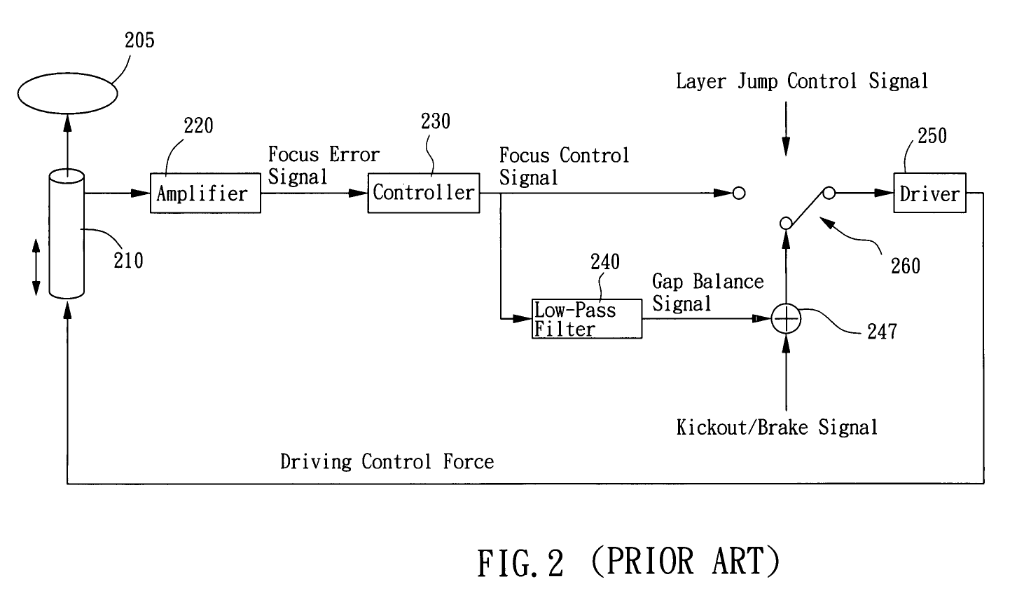

FIG. 3 is a schematic timing diagram illustrating a layer jumping process performed by a pickup head.

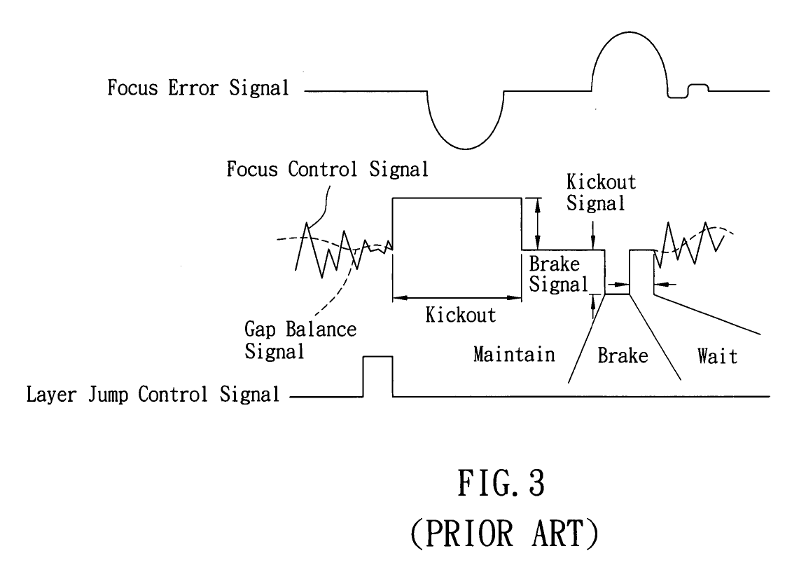

FIG. 4 is a flow chart of an embodiment for controlling half-wave layer jumping of a pickup head.

FIG. 5 is a block diagram of an embodiment for controlling half-wave layer jumping of a pickup head.

FIG. 6 is a schematic timing diagram illustrating a half-wave layer jumping process according to an embodiment.

### DESCRIPTION

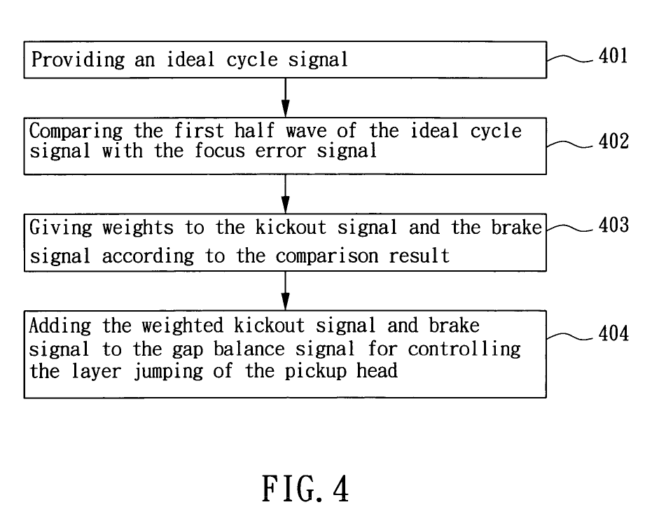

Please refer to FIG. 4 for a flow chart of an exemplary method of controlling half-wave layer jumping of a pickup head according to some embodiments of the present invention. An ideal half-wave cycle signal is provided, which is a signal having an ideal first half-wave cycle of a focus error signal used for layer jumping. This step is referred to as Step 401.

The duration of the ideal half-wave cycle and the first half wave of the focus control signal are compared in Step 402. For example, the first half wave of the focus control signal is compared with a predetermined signal level, and a counter is used to count an actual half-wave cycle. The difference between the ideal half-wave cycle and the actual half-wave cycle is regarded as an error.

The comparison result obtained in Step 402, which is regarded to as the error, is the input of the half-wave layer jump controller for calculating a half-wave compensation control signal. This step is referred to as Step 403.

Finally, the output logic receives the kickout signal, the control signal and brake signal output from the half-wave layer jump controller, and determines the output timing, the siganl is then added to the gap balance signal as a driving force for controlling layer jumping of the pickup head. This step is referred to as Step 404.

Since the layer jumping movements of the pickup head is mainly controlled by adding a kickout signal and a brake signal onto a gap balance signal generated by passing a focus control signal through a low-pass filter, where the focus control signal is generated from a focus error signal through a controller. This method measures the wavelength of the first half-wave of the focus error signal during layer jumping, and compares the wavelength of the focus error signal with the wavelength of the ideal half-wave cycle , and at the end of the first half-wave of layer jumping process, outputs a compensation control force according to the vibration effect when the optical pickup head performs layer jumping. A large error between the half wavelength of the focus error signal and its ideal cycle indicates layer jumping is experiencing more influence due to vibration; and vice versa. The polarity of the error indicates the direction of compensation. The vibration effect during layer jumping can be computed by such comparison for controlling the driving force in layer jumping.

The focus error signal generated during layer jumping of the pickup head is compared with its predetermined ideal cycle signal, and the error produced from the comparison result is weighted on the gap balance signal for effectively compensating the vibration effect during layer jumping, and more particularly for the pickup head operated at high-speed.

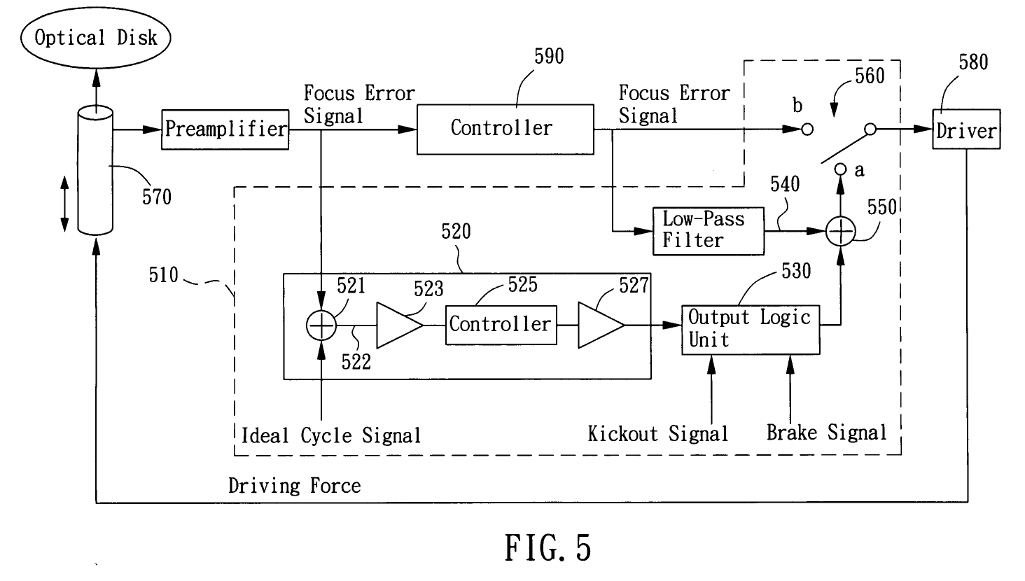

Please refer to FIG. 5 for a schematic diagram of an apparatus for controlling half-wave layer jumping of a pickup head according to an embodiment of the present invention. The half-wave Layer Jump Control apparatus 510 comprises a half-wave Layer Jump Controller 520 and an output logic unit 530; wherein the half-wave Layer Jump Controller 520 comprises an adder 521, a gain amplifier 523, a controller 525, and another gain amplifier 527.

Further, the half-wave Layer Jump Control apparatus 510 determines the control force for layer jumping based on a gap balance signal. The layer jump control apparatus 510 further comprises a low-pass filter 540, an adder 550, and a switch 560.

When the pickup head 570 jumps from a layer to another layer, the electronic switch 560 switches from Point b to Point a. The adder 521 of the half-wave layer jump controller 520 receives a focus error signal and an ideal half-wave cycle, and outputs a difference between the measured actual half wavelength of the focus error signal and the ideal half-wave cycle. The output of the adder 521 is therefore an error 522 between the half wavelength of the focus error signal and the ideal half-wave cycle. The error 522 output to the output logic unit 530 after processing by the controller 525, and the gain amplifiers 523 and 527.

The output logic unit 530 operates according to the output of the gain amplifier 527, which is the output of the half-wave layer jump controller 520, and the received kickout signal and brake signal, and determines the output timing for these signals to output the control signal according to the vibration effect during layer jumping of a pickup head.

The kickout signal, half-wave control compensation, and brake signal are added onto the gap balance signal by the adder 550, and the sum is provided to the driver 580. The driver 580 thus outputs the driving force for the optical pickup head 570 to perform layer jumping.

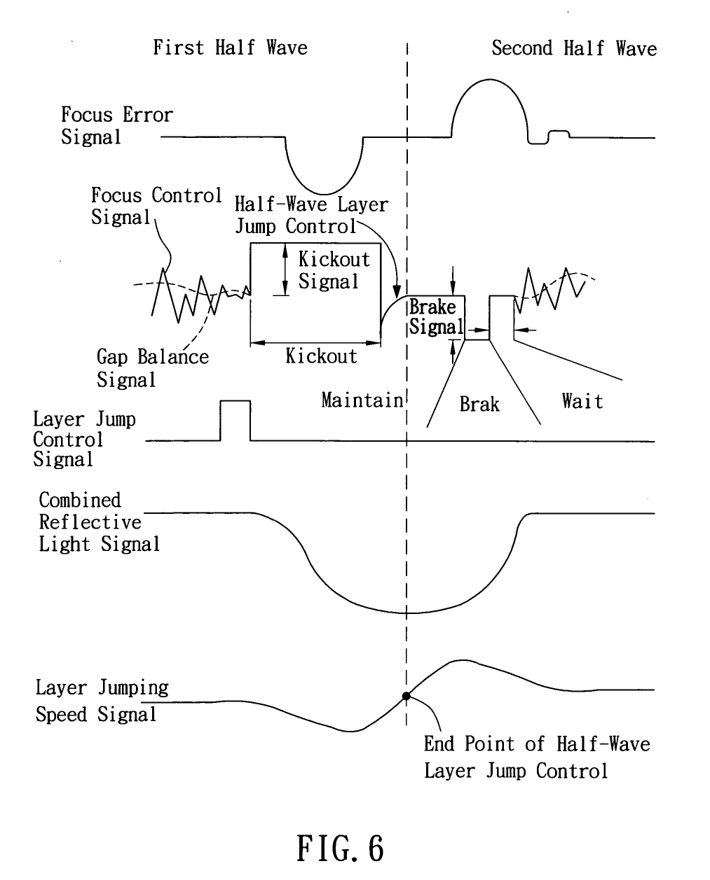

Please refer to FIG. 6 for a schematic timing diagram illustrating an exemplary half-wave layer jump control. The falling edge of the layer jump control signal initiates the pickup head to perform layer jumping. The kickout signal and brake signal will be added onto the gap balance signal after passing the focus control signal through the low-pass filter so as to enhance the stability by keeping a continuous driving force for layer jumping.

If a kickout is applied (when the focus error signal is at the first half-wave cycle), two points F₁ and F₂ at a level of the focus error signal can be obtained as a reference for determining the length of a half-wave cycle, and this length is compared with an ideal cycle of the focus error signal to obtain an error. The error computed by the controller gives weights to the gap balance signal at the finishing point of the kickout signal as a compensation control before completing the first half wave of the layer jumping operation. An additional compensation force is thus provided by a half-wave layer jumping control at the finishing of the first half-wave cycle of the focus error signal for controlling the pickup head to maintain a constant speed for layer jumping. The pickup head can have a more precise entry point for various layer jumping stages such as holding, braking, waiting, and close-loop focus control at the second half-wave cycle of the focus error signal, and the better consistency enables easier parameter adjustment.

The half-wave layer jumping control diminishes the vibration effect induced during layer jumping of the pickup head. The stability of the layer jumping operation of a pickup head may be enhanced by compensating the vibration effects.

Please refer to FIG. 6. The end point of the half-wave control is situated at the mid-point of the layer jumping speed signal; wherein the layer jumping speed signal is obtained by taking the first derivative of a combined reflective light output from the preamplifier as shown in FIG. 5. In addition, the waveform of the layer jumping speed signal is very smooth, which indicates the layer jumping speed of the pickup head is stable.

In summation of the above description, the present invention provides methods and apparatuses for controlling half-wave layer jumping of an optical disk drive by comparing the first half wave of the focus error signal with an ideal cycle signal, and the controller computes the weighting based on the comparison result for the gap balance signal to act as an additional compensation force to compensate the vibration effect during layer jumping. Embodiments of the present invention effectively enhance the stability of the layer jumping operation performed by a pickup head.

What is claimed is:

1. An apparatus of half-wave layer jump control for a pickup head in an optical disk drive, comprising:
a half-wave layer jump controller, for receiving a focus error signal to generate a half-wave control signal according to the focus error signal; and
an output logic unit, for receiving the half-wave control signal, a kickout signal, and a brake signal, determing an output timing of the received signal to output the kickout signal, half-wave control signal, and brake signals, and the output signal is added onto a gap balance signal for controlling layer jumping of the pickup head.

2. The apparatus of claim 1, wherein the half-wave layer jump controller further comprises:
an adder, receiving the half-wave cycle of the focus error signal and a half-wave cycle of an ideal cycle signal to compute an error;
a first gain amplifier, receiving the error output from the adder and outputting an amplified error;
a controller, receiving and controlling the amplified error from the first gain amplifier; and
a second gain amplifier, receiving and amplifying the output of the controller to generate the control signal.

3. The apparatus of claim 1, further comprising:
a controller, receiving the focus error signal; and
a low-pass filter, for receiving a focus control signal output from the controller, and generating the gap balance signal by low-passing the focus control signal.

4. The apparatus of claim 3 further comprising:
an adder, receiving and adding the gap balance signal and the output from the output logic unit for controlling layer jumping of the pickup head.

5. The apparatus of claim 4, further comprising:
a driver, controlling layer jumping of the pickup head; and
a switch, switching an input of the driver between the focus control signal output from the controller and an output of the adder.

6. The apparatus of claim 4, wherein the optical disk drive is a DVD drive.

7. A method of half-wave layer jump control for pickup head of optical disk drive, comprising:
providing an ideal cycle signal;
comparing the ideal cycle signal with a first wave cycle of a focus error signal used in layer jumping of the pickup head; and
giving weights to a gap balance signal according to the comparing result.

8. The method of claim 7 further comprising:
comparing the ideal cycle signal and the first half-wave cycle of the focus error signal, wherein the first half-wave cycle of the focus error signal is obtained by comparing a predetermined signal level and the focus error signal.

9. The method of claim 8 further comprising:
obtaining an error between the ideal cycle signal and the first half-wave cycle of the focus error signal for half-wave compensation during layer jumping; and

10. The method of claim 9 further comprising:
adding the half-wave compensation signal, kickout signal, and brake signal to a gap balance signal for controlling the layer jumping of the pickup head.

11. The method of claim 10 further comprising:
generating a focus control signal based on the filtered focus error signal; and
low-pass filtering the focus control signal to generate the gap balance signal.
